(19) United States
(12) Patent Application Publication
(10) Pub. No.: US 2026/0099561 A1
(43) Pub. Date: Apr. 9, 2026

(54) INFORMATION PRESENTATION METHOD, MEDIUM, AND ELECTRONIC DEVICE

(71) Applicant: Beijing Youzhuju Network Technology Co., Ltd., Beijing (CN)

(72) Inventors: Jinming ZHANG, Beijing (CN); Jiaqian ZHANG, Beijing (CN); Fei WANG, Beijing (CN); Senran CHEN, Beijing (CN); Han XU, Beijing (CN); Jin BAI, Beijing (CN)

(21) Appl. No.: 19/332,818

(22) Filed: Sep. 18, 2025

(30) Foreign Application Priority Data
Oct. 8, 2024 (CN) 202411399690.2

(51) Int. Cl. G06F 16/957; G06T 17/10

(52) U.S. Cl. CPC G06F 16/9577; G06T 17/10

(57) ABSTRACT

The present disclosure relates to an information presentation method and apparatus, a medium, an electronic device, and a program product. The method includes: displaying a first multimedia resource and a second multimedia resource, wherein the first multimedia resource and the second multimedia resource are multimedia resources associated with a target object; and displaying at least portion of a target element in the first multimedia resource moving to the second multimedia resource, wherein the at least portion of the target element is an element associated with the target object.

### CROSS-REFERENCE TO RELATED APPLICATION

The present application claims the priority to Chinese Patent Application No. 202411399690.2, filed on Oct. 8, 2024, the entire disclosure of which is incorporated herein by reference as portion of the present application.

### TECHNICAL FIELD

The present disclosure relates to an information presentation method, an apparatus, a medium, an electronic device, and a program product.

### BACKGROUND

With the development of Internet technologies, users are increasingly acquiring information through presented pages. However, a page usually carries a lot of information, and information in page modules is independent of each other and lacks association between each other, which causes users to easily overlook information displayed in the page. This reduces the efficiency of information dissemination and the efficiency of users in acquiring information.

### SUMMARY

This Summary is provided to introduce concepts in a simplified form that are described in detail in the following Detailed Description. This Summary is not intended to identify key features or essential features of the claimed technical solution, nor is it intended to be used to limit the scope of the claimed technical solution.

In a first aspect, the present disclosure provides an information presentation method, including:
displaying a first multimedia resource and a second multimedia resource, where the first multimedia resource and the second multimedia resource are multimedia resources associated with a target object; and
displaying at least portion of a target element in the first multimedia resource moving to the second multimedia resource, where the at least portion of the target element is an element associated with the target object.

In a second aspect, the present disclosure provides an information presentation apparatus, including:
a first display module configured to display a first multimedia resource and a second multimedia resource, where the first multimedia resource and the second multimedia resource are multimedia resources associated with a target object; and
a second display module configured to display at least portion of a target element in the first multimedia resource moving to the second multimedia resource, where the at least portion of the target element is an element associated with the target object.

In a third aspect, the present disclosure provides a computer-readable medium having a computer program stored thereon, where the computer program, when executed by a processing apparatus, implements the method according to the first aspect.

In a fourth aspect, the present disclosure provides an electronic device, including:
a storage apparatus having a computer program stored thereon; and
a processing apparatus configured to execute the computer program in the storage apparatus to implement the method according to the first aspect.

In a fifth aspect, the present disclosure provides a computer program product, including a computer program, where the computer program, when executed by a processor, implements the steps of the method according to the first aspect.

### BRIEF DESCRIPTION OF DRAWINGS

The above and other features, advantages, and aspects of embodiments of the present disclosure will become more apparent when taken in conjunction with the drawings and with reference to the following detailed description. Throughout the drawings, the same or similar reference numbers refer to the same or similar elements. It should be understood that the drawings are schematic and that parts and elements are not necessarily drawn to scale. In the drawings:

FIG. 1 is a flowchart of an information presentation method according to some embodiments;

FIG. 2 is a schematic diagram of displaying a first multimedia resource and a second multimedia resource according to some embodiments;

FIG. 3 is a schematic diagram of a target element moving to a second multimedia resource according to some embodiments;

FIG. 4 is a schematic diagram of a target element moving to a second multimedia resource according to some other embodiments;

FIG. 5 is a schematic diagram of a glasses-free three-dimensional effect according to some embodiments;

FIG. 6 is a schematic diagram of a background page according to some embodiments;

FIG. 7 is a schematic diagram of a jump control according to some embodiments;

FIG. 8 is a schematic diagram of module connection of an information presentation apparatus according to some embodiments; and

FIG. 9 is a schematic structural diagram of an electronic device according to some embodiments.

### DETAILED DESCRIPTION

Embodiments of the present disclosure will be described in more detail below with reference to the drawings. While some embodiments of the present disclosure are shown in the drawings, it should be understood that the present disclosure may be implemented in various forms and should not be construed as limited to the embodiments set forth herein. Rather, these embodiments are provided for a more thorough and complete understanding of the present disclosure. It should be understood that the drawings and embodiments of the present disclosure are only for illustrative purposes and are not intended to limit the scope of the present disclosure.

It should be understood that the steps described in the method implementations of the present disclosure may be performed in different orders and/or in parallel. In addition, the method implementations may include additional steps and/or omit to perform the illustrated steps. The scope of the present disclosure is not limited in this respect.

The term “include/comprise” and variations thereof as used herein are open-ended inclusions, that is, “include/comprise but not limited to”. The term “based on” is “based at least in part on”. The term “one embodiment” means “at least one embodiment”; the term “another embodiment” means “at least one additional embodiment”; and the term “some embodiments” means “at least some embodiments”. Related definitions of other terms will be given in the following description.

It should be noted that the concepts of “first” and “second” etc. mentioned in the present disclosure are only used to distinguish between different apparatuses, modules or units, and are not used to limit the order or interdependence of the functions performed by these apparatuses, modules or units.

It should be noted that the modifications of “one” and “a plurality of” mentioned in the present disclosure are illustrative rather than restrictive, and those skilled in the art should understand that they should be understood as “one or more” unless the context clearly indicates otherwise.

The names of messages or information exchanged between apparatuses in the implementations of the present disclosure are only used for illustrative purposes, and are not used to limit the scope of these messages or information.

It should be understood that, before using the technical solutions disclosed in the embodiments of the present disclosure, users should be informed of the type, use scope, use scenario, etc. of personal information involved in the present disclosure through appropriate means according to relevant laws and regulations, and the authorization of users should be obtained.

For example, in response to receiving an active request from a user, prompt information is sent to the user to explicitly prompt the user that the operation requested by the user will require the acquisition and use of the user's personal information. Thus, the user can choose whether to provide personal information to software or hardware, such as an electronic device, an application, a server, or a storage medium, that performs the operation of the technical solution of the present disclosure based on the prompt information.

As an optional but non-limiting implementation, the manner of sending prompt information to the user in response to receiving the active request from the user may be, for example, a pop-up window, and the prompt information may be presented in a text form in the pop-up window. In addition, the pop-up window may also carry a selection control for the user to choose “agree” or “disagree” to provide personal information to the electronic device.

It should be understood that the above process of notifying and acquiring user authorization is only schematic, and does not limit the implementations of the present disclosure, and other manners that meet relevant laws and regulations may also be applied to the implementations of the present disclosure.

Furthermore, it should be understood that data involved in the technical solution (including but not limited to the data itself, the acquisition or use of the data) should comply with the requirements of relevant laws, regulations and related regulations.

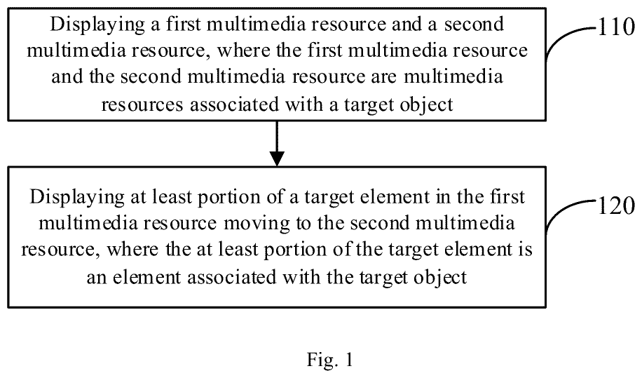

FIG. 1 is a flowchart of an information presentation method according to some embodiments. As shown in FIG. 1, the embodiments of the present disclosure provide an information presentation method, which may be executed by an electronic device, and in particular, may be executed by an information presentation apparatus. The apparatus may be implemented in software and/or hardware, and is configured in the electronic device. As shown in FIG. 1, the method may include the following steps.

Step 110, displaying a first multimedia resource and a second multimedia resource, where the first multimedia resource and the second multimedia resource are multimedia resources associated with a target object.

Here, in the embodiments of the present disclosure, a multimedia resource may be a multimedia resource of an image type such as a video, a carousel picture (that is, a picture group composed of multiple pictures), and the like. Certainly, the multimedia resource may also be an audio resource.

The first multimedia resource and the second multimedia resource are multimedia resources used to describe the target object. The first multimedia resource and the second multimedia resource both include the target object, and the target object may refer to a main item or a main character in the multimedia resource. Taking a multimedia resource being a promotional video as an example, the target object may refer to a product corresponding to the promotional video.

In some examples, the first multimedia resource and the second multimedia resource may be displayed on an application interface. Certainly, in other examples, the first multimedia resource and the second multimedia resource may be displayed at different positions of a page. In the embodiments of the present disclosure, the first multimedia resource and the second multimedia resource are displayed in different areas. Taking the application interface as an example, the first multimedia resource and the second multimedia resource may be displayed through different interface modules of the application interface.

It should be noted that the first multimedia resource and the second multimedia resource may be configured by a user. Taking information promotion as an example, an advertiser may configure the corresponding first multimedia resource and the corresponding second multimedia resource in a page. Certainly, the second multimedia resource may also be pulled from a server. For example, the second multimedia resource may be a live streaming video obtained from the server.

Step 120, displaying at least portion of a target element in the first multimedia resource moving to the second multimedia resource, where the at least portion of the target element is an element associated with the target object.

Here, the at least portion of the target element in the first multimedia resource is an element associated with the target object. Exemplarily, the at least portion of the target element may refer to all of the target object or a portion of the target object. For example, if the target object is beer, the target element may be a complete beer bottle. Certainly, the target element may also be a bottle cap of the beer bottle. For another example, if the target object is a cosmetic, the target element may be a complete cosmetic body. Certainly, the target element may also be a special ingredient in the cosmetic.

During the process of displaying the first multimedia resource and the second multimedia resource, the at least portion of the target element in the first multimedia resource is displayed to move from the first multimedia resource to the second multimedia resource, so as to display the association between the second multimedia resource and the first multimedia resource visually.

It should be understood that the displayed first multimedia resource and the displayed second multimedia resource may be in a playback state at the beginning. Certainly, in some scenarios, the displayed first multimedia resource may be in the playback state at the beginning, and when the target element moves to the second multimedia resource, the second multimedia resource starts to play, so as to reflect the association between the second multimedia resource and the first multimedia resource.

It should be noted that when a plurality of second multimedia resources are displayed, the target element may be displayed to move to each of the second multimedia resources. Certainly, when a plurality of second multimedia resources are displayed, the target element may also be displayed to move to a target second multimedia resource among the plurality of second multimedia resources. The target second multimedia resource may be a second multimedia resource closest to the first multimedia resource among the plurality of second multimedia resources.

In some embodiments, when the first multimedia resource is displayed to a preset node, the target element in the first multimedia resource may be displayed to move to the second multimedia resource. The preset node may be set according to actual situations.

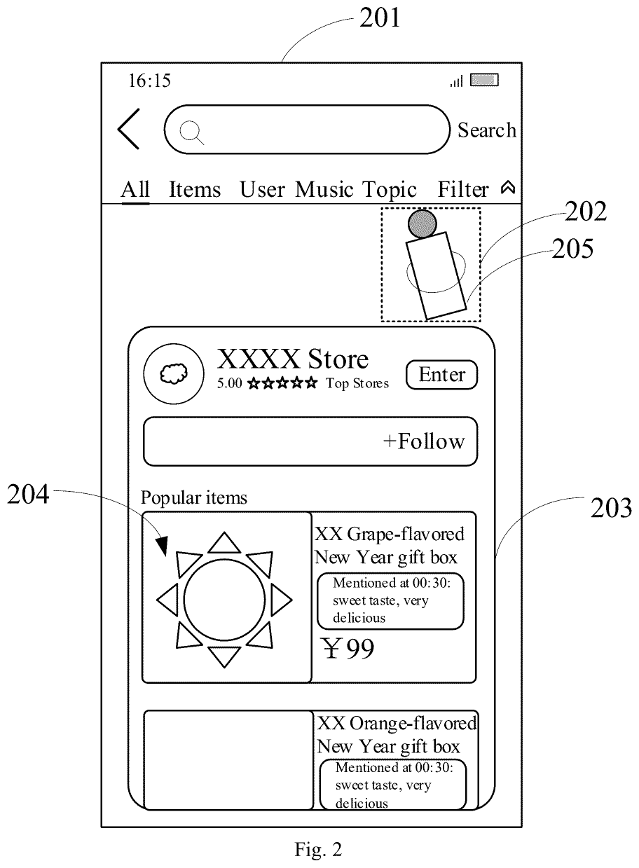

FIG. 2 is a schematic diagram of displaying a first multimedia resource and a second multimedia resource according to some embodiments. As shown in FIG. 2, a first multimedia resource 202 is displayed in a first area of an application interface 201, an information presentation page 203 is displayed in the first area of the application interface 201, and a second multimedia resource 204 is displayed on the information presentation page 203. The first multimedia resource 202 includes a target object 205.

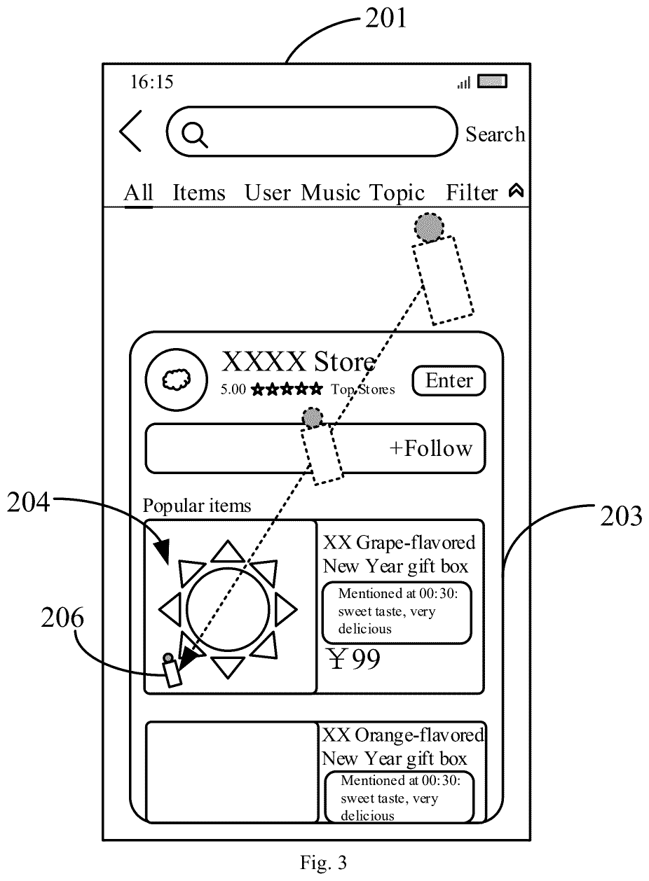

FIG. 3 is a schematic diagram of a target element moving to a second multimedia resource according to some embodiments. As shown in FIG. 3, the entire target object 205 in the first multimedia resource 202 is used as a target element 206, and the target element 206 moves to the second multimedia resource 204.

It should be noted that when a part of the target object 205 is used as the target element 206 to move on the second multimedia resource 204, the first multimedia resource 202 may no longer be displayed in the first area of the application interface 201. That is, after the first multimedia resource 202 is displayed, it seamlessly transitions to display the target element 206 in the first multimedia resource 202 moving from the first multimedia resource 202 to the second multimedia resource 204. Certainly, when a portion of the target object 205 is used as the target element 206 to move to the second multimedia resource 204, other multimedia resources associated with the target object may also be displayed in the first area.

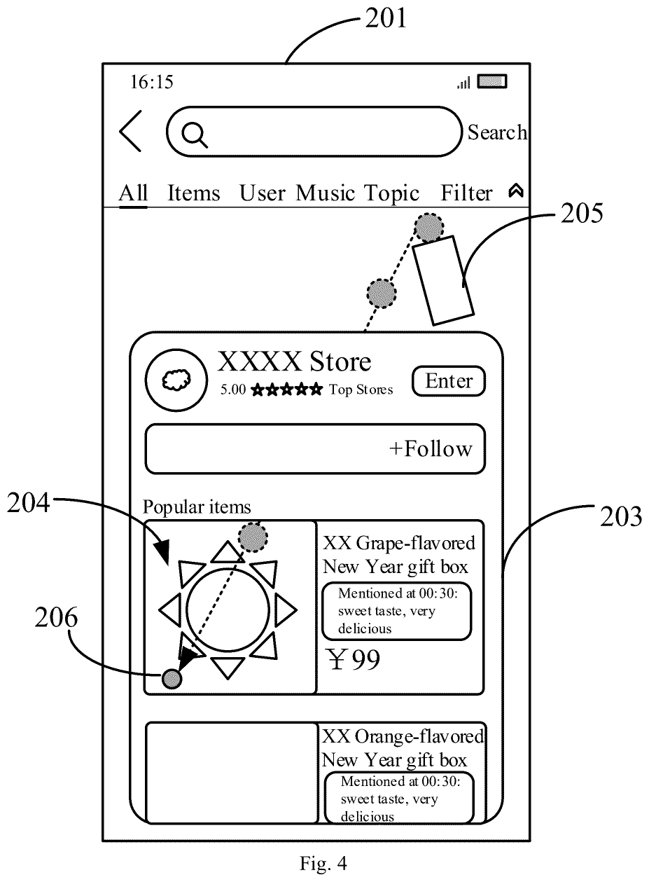

FIG. 4 is a schematic diagram of a target element moving to a second multimedia resource according to some other embodiments. As shown in FIG. 4, a portion of the target object 205 in the first multimedia resource 202 is used as a target element 206, and the target element 206 moves to the second multimedia resource 204.

It should be noted that when a portion of the target object 205 is used as the target element 206 to move to the second multimedia resource 204, the first multimedia resource 202 may continue to be displayed in the first area of the application interface 201, but the target element that moves to the second multimedia resource 204 will be missing in the first multimedia resource 202 that continues to be displayed.

As shown in FIG. 3 and FIG. 4, there may be two trajectories of the target element 206 moving to the second multimedia resource 204. As shown in FIG. 3, the target element 206 moves from the first multimedia resource 202 to the information presentation page 203, and then moves from the information presentation page 203 to the second multimedia resource 204. As shown in FIG. 4, the target element 206 passes through the information presentation page 203 and moves from a lower layer of the information presentation page 203 to the second multimedia resource 204.

It should be noted that how to display the at least portion of the target element in the first multimedia resource moving to the second multimedia resource is not specifically limited in the embodiments, and the at least portion of the target element in the first multimedia resource moving to the second multimedia resource may be displayed in any implementable manner. For example, the at least portion of the target element in the first multimedia resource may be displayed to move to the second multimedia resource by displaying a preset animation resource.

Thus, by displaying the first multimedia resource and the second multimedia resource, and displaying the at least portion of the target element in the first multimedia resource moving to the second multimedia resource, the connection between the first multimedia resource and the second multimedia resource can be embodied at the visual level, so that the displayed first multimedia resource and the displayed second multimedia resource can be associated through the target element, which avoids users from overlooking information displayed in the multimedia resource. This can not only improve the efficiency of information dissemination of the multimedia resource, but also ensure that users can quickly acquire information, and greatly improve the efficiency of information acquisition by users.

In some implementable implementations, in step 110, the first multimedia resource may be displayed in a first area of the application interface, and a corresponding information presentation page for presenting the target object is displayed in a second area of the application interface, where the second multimedia resource is displayed on the information presentation page.

Here, the application interface may be an interface of an application. For example, if the application is a short video application, the application interface may be an interface of the short video application. Certainly, the application interface may be an interface of a webpage.

The first multimedia resource is displayed in the first area of the application interface, and the information presentation page including the second multimedia resource is displayed in the second area of the application interface. Correspondingly, the target element is displayed to move from the first area to the second multimedia resource located in the second area. As shown in FIG. 2, the first area of the application interface may be a top area of the application interface, and the second area of the application interface may be an area below the top area of the application interface.

Certainly, the first area may also be an area of the application interface that enables the first multimedia resource displayed in the first area to interact with an interface element in the application interface to form a glasses-free three-dimensional effect. The first multimedia resource interacting with the interface element to form the glasses-free three-dimensional effect may be that the first multimedia resource can at least partially block the interface element in the application interface, allowing the first multimedia resource to overlay and cooperate with the interface element to form the glasses-free three-dimensional effect. That is, the first multimedia resource interacts with the interface element of the application interface to form a visual effect that the first multimedia resource breaks the limitation of the application interface.

The information presentation page is used to display related information of the target object. Taking the target object being a promoted product as an example, the information presentation page may be used to display related information such as introduction information, a purchase link, and promotional activity information of the promoted product.

The second multimedia resource is displayed on the information presentation page. As shown in FIG. 2, the second multimedia resource 204 is displayed on the information presentation page 203.

It should be noted that the first multimedia resource and the information presentation page may be in the same page. In some embodiments, in response to a search term input by a user, a target page corresponding to the search term may be displayed on the application interface, and the first multimedia resource and the information presentation page associated with the target object corresponding to the search term are displayed on the target page. It should be understood that the style of the information presentation page may be different for different search terms.

Thus, through the above implementations, the first multimedia resource and the second multimedia resource can be displayed in different areas of the application interface, so as to display the target element moving from the first area to the second area during the subsequent process, so that the visual association can be formed between the first multimedia resource displayed in the first area and the second multimedia resource displayed in the second area.

Based on the above implementations, in some implementable implementations, the target element may be displayed to move from a lower layer of the information presentation page to the second multimedia resource.

Here, the target element moving from the lower layer of the information presentation page to the second multimedia resource refers to that the target element passes through the lower layer of the information presentation page and moves to the second multimedia resource.

As shown in FIG. 4, the target element 206 passes through the lower layer of the information presentation page 203 and moves to the second multimedia resource 204.

Thus, by displaying the target element moving from the lower layer of the information presentation page to the second multimedia resource, the information on the information presentation page can be prevented from being blocked by the target element, which greatly ensures the presentation effect of the information presentation page.

Based on the above implementations, in some implementable implementations, the first multimedia resource may be displayed in a first area of a resource display layer located at an upper layer of the application interface.

Here, the resource display layer is overlaid on the upper layer of the application interface. That is, the resource display layer may be located between the application interface and the information presentation page. The resource display layer, as a display layer, is used to display a multimedia resource. Taking the multimedia resource being a video as an example, the resource display layer may be understood as a video playing layer.

The first multimedia resource displayed in the first area can interact with an interface element of the application interface to form a glasses-free three-dimensional effect.

At least part of the first multimedia resource displayed in the first area of the resource display layer can interact with the interface element of the application interface to form the glasses-free three-dimensional effect. The first multimedia resource interacting with the interface element to form the glasses-free three-dimensional effect may refer to that at least part of elements of the first multimedia resource can block the interface element in the application interface, allowing the first multimedia resource to overlay and cooperate with the interface element to form the glasses-free three-dimensional effect. That is, the first multimedia resource interacts with the interface element of the application interface to form a visual effect that the first multimedia resource breaks the limitation of the application interface and goes out of the frame of the application interface.

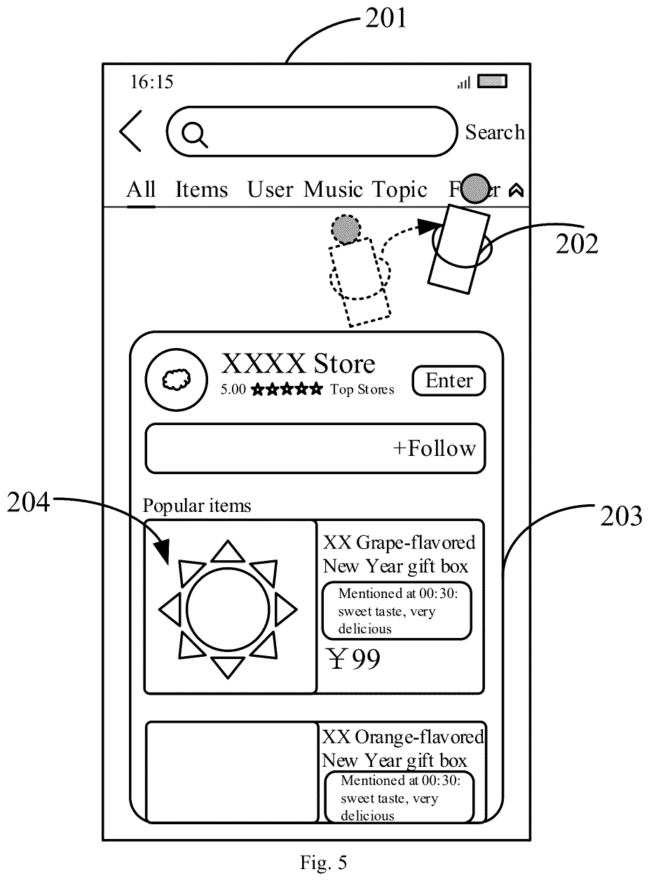

FIG. 5 is a schematic diagram of a glasses-free three-dimensional effect according to some embodiments. As shown in FIG. 5, during the process of displaying the first multimedia resource 202, at least part of elements of the first multimedia resource 202 can block interface elements in the application interface 201 to form the glasses-free three-dimensional effect.

Thus, through the above implementations, the first multimedia resource can present the glasses-free three-dimensional effect, which can improve the display effect of the multimedia resource and improve the experience of users in acquiring resources.

Based on the above implementations, in some implementable implementations, the second multimedia resource is displayed in a second area of the resource display layer, and the information presentation page is displayed through a page layer located at an upper layer of the resource display layer.

Here, the second multimedia resource is displayed in the second area of the resource display layer, so that the at least part of the target element in the first multimedia resource can move to the second multimedia resource through the resource display layer.

The page layer is overlaid on the upper layer of the resource display layer, and the information presentation page is displayed in the page layer located at the upper layer of the resource display layer. That is, the information presentation page may be a page overlaid on the second multimedia resource. It should be noted that the information presentation page overlaid on the second multimedia resource will not block the display of the second multimedia resource.

It should be understood that by displaying the information presentation page in the page layer located at the upper layer of the resource display layer and displaying the second multimedia resource in the second area of the resource display layer, the target element may be displayed to move from the first multimedia resource to the second multimedia resource in the resource display layer, so that the target element passes through the information presentation page from the lower layer of the information presentation page and moves to the second multimedia resource displayed in the resource display layer.

Thus, through the above implementations, the information in the information presentation page can be prevented from being blocked by the target element, which greatly ensures the display effect of the information presentation page.

Based on the above implementations, in some implementable implementations, a background page associated with the target object may also be displayed on a lower layer of the first multimedia resource.

Here, the background page associated with the target object may be a background page configured by a user according to requirements. Exemplarily, the background page may be located on a lower layer of the resource display layer. By displaying the background page on the lower layer of the first multimedia resource, the first multimedia resource can be displayed on the background page, so that the first multimedia resource and the background page can cooperate to display the related information of the target object.

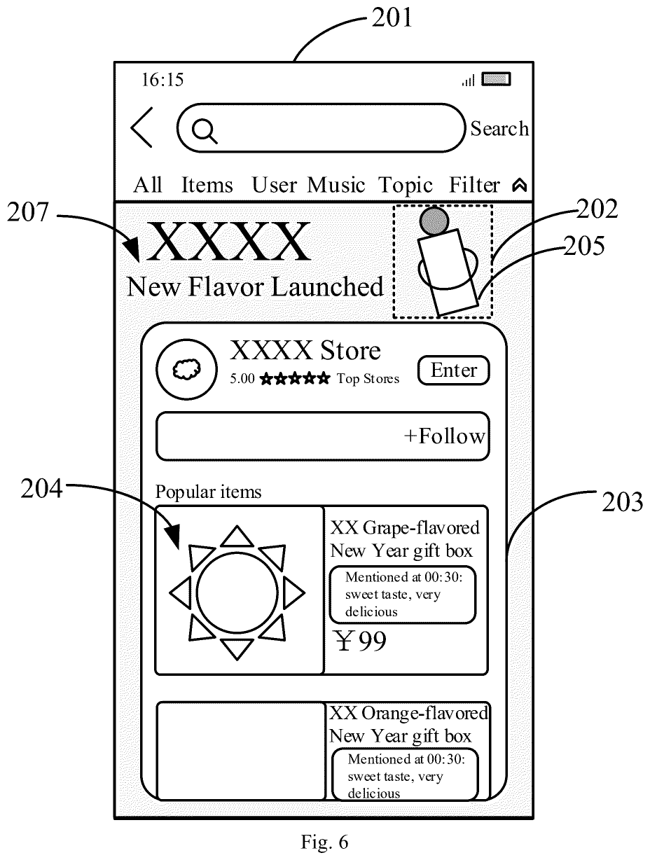

FIG. 6 is a schematic diagram of a background page according to some embodiments. As shown in FIG. 6, a background page 207 is located on a lower layer of the first multimedia resource 202. Certainly, because the information presentation page 203 is located on the upper layer of the resource display layer, the background page 207 is also located on a lower layer of the information presentation page 203.

Thus, by displaying the background page, more related information of the target object can be carried, so as to improve the efficiency of users in acquiring information.

Based on the above implementations, in some implementable implementations, the target element moved to the second multimedia resource may also be displayed as a jump control, where the jump control is configured to display a landing page associated with the target object in response to a trigger operation.

Here, after the target element is moved to the second multimedia resource, the target element may be controlled to switch to a jump control. The jump control may display the landing page associated with the target object in response to a trigger operation on the jump control. The trigger operation may be a click operation or other operations. When the user clicks on the jump control, the landing page associated with the target object is displayed, so that the user can acquire more messages related to the target object through the landing page. Taking the target object being a promoted product as an example, the landing page may be a page for purchasing the promoted product.

Exemplarily, the jump control may carry the target object, so as to reflect the association between the jump control and the first multimedia resource and the second multimedia resource.

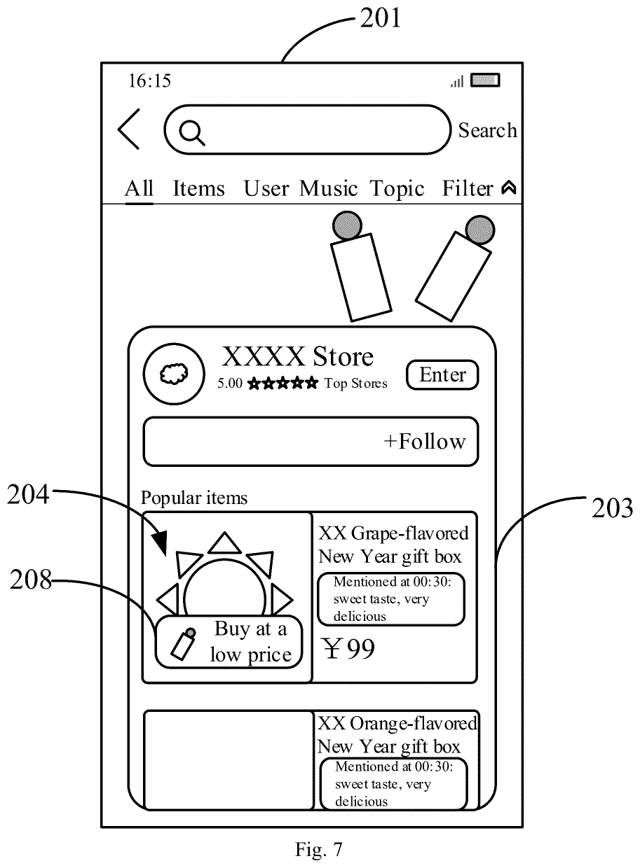

FIG. 7 is a schematic diagram of a jump control according to some embodiments. As shown in FIG. 7, a jump control 208 is displayed on the second multimedia resource 204. Through the displayed jump control 208, the user can click on the jump control 208 to jump to the landing page associated with the target object.

Thus, by displaying the target element moved to the second multimedia resource as the jump control, the user can jump to the corresponding landing page by clicking on the second multimedia resource, which can not only avoid the user from missing the information of the second multimedia resource, but also enable the user to acquire more related information of the target object through the jump control.

Based on the above implementations, in some implementable implementations, in step 120, a preset animation resource may be displayed on the first multimedia resource, where the preset animation resource is used to describe the target element moving to the second multimedia resource.

Here, the preset animation resource may be an animation resource that is seamlessly connected to the first multimedia resource and used to describe the target element in the first multimedia resource moving to the second multimedia resource.

In some embodiments, the preset animation resource may be displayed in the resource display layer, to move the at least portion of the target element in the first multimedia resource to the second multimedia resource.

It should be noted that the first multimedia resource and the preset animation resource may be provided by a user, such as an advertiser providing the corresponding first multimedia resource and the preset animation resource.

It should be noted that the preset animation resource displayed in the resource display layer can also interact with the interface elements of the application interface to form the glasses-free three-dimensional effect, so that the target element can break the display of the application interface and move to the second multimedia resource visually.

In some scenarios, the electronic device may display a page including the first multimedia resource, the second multimedia resource, and the information presentation page in response to a search term input by a user. When displaying the page, the first multimedia resource may be played, and when the first multimedia resource is played to a preset node, the preset animation resource is played to move the at least portion of the target element in the first multimedia resource to the second multimedia resource, and then the at least portion of the target element moved to the first multimedia resource is switched to the jump control. When the user clicks on the jump control, the landing page associated with the target object is displayed.

Thus, through the preset animation resource, the at least portion of the target element in the first multimedia resource can be moved to the second multimedia resource.

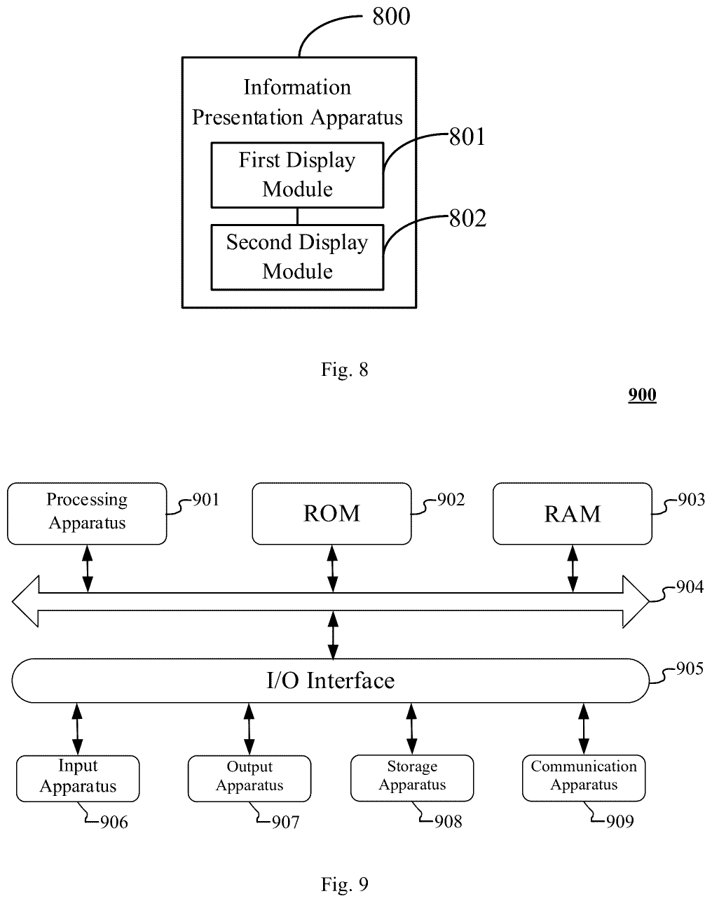

FIG. 8 is a schematic diagram of module connection of an information presentation apparatus according to some embodiments. As shown in FIG. 8, the embodiments of the present disclosure provide an information presentation apparatus 800, and the information presentation apparatus 800 includes:
a first display module 801 configured to display a first multimedia resource and a second multimedia resource, where the first multimedia resource and the second multimedia resource are multimedia resources associated with a target object; and
a second display module 802 configured to display at least portion of a target element in the first multimedia resource moving to the second multimedia resource, where the at least portion of the target element is an element associated with the target object.

Optionally, the first display module 801 is further configured to:
display the first multimedia resource in a first area of an application interface, and display a corresponding information presentation page for presenting the target object in a second area of the application interface, where the second multimedia resource is displayed on the information presentation page.

Optionally, the second display module 802 is further configured to:
display the target element moving from a lower layer of the information presentation page to the second multimedia resource.

Optionally, the second display module 802 is further configured to:
display the first multimedia resource in a first area of a resource display layer located at an upper layer of the application interface, where the first multimedia resource displayed in the first area of the resource display layer is capable of interacting with an interface element of the application interface to form a glasses-free three-dimensional effect.

Optionally, the second multimedia resource is displayed in a second area of the resource display layer, and the information presentation page is displayed through a page layer located at an upper layer of the resource display layer.

Optionally, the information presentation apparatus 800 further includes:
a third display module configured to display the target element moved to the second multimedia resource as a jump control, where the jump control is configured to display a landing page associated with the target object in response to a trigger operation.

Optionally, the second display module 802 is further configured to:
display a preset animation resource on the first multimedia resource, where the preset animation resource is used to describe the target element moving to the second multimedia resource.

Regarding the method logic executed by the above functional modules in the information presentation apparatus 800, reference may be made to the method part related to the above embodiments, and details will not be repeated here.

Reference is made to FIG. 9 below, which illustrates a schematic structural diagram of an electronic device (e.g., a terminal device) 900 suitable for implementing the embodiments of the present disclosure. The terminal device in the embodiments of the present disclosure may include, but is not limited to, mobile terminals such as a mobile phone, a notebook computer, a digital broadcast receiver, a personal digital assistant (PDA), a tablet computer, a portable multimedia player (PMP), a vehicle-mounted terminal (such as a vehicle-mounted navigation terminal), and fixed terminals such as a digital TV, a desktop computer, and the like. The electronic device shown in FIG. 9 is only an example, and should not bring any limitation to the function and use scope of the embodiments of the present disclosure.

As shown in FIG. 9, the electronic device 900 may include a processing apparatus (e.g., a central processing unit, a graphics processor, etc.) 901 that can perform various appropriate actions and processes according to a program stored in a read-only memory (ROM) 902 or a program loaded from a storage apparatus 908 into a random access memory (RAM) 903. The RAM 903 further stores various programs and data required for the operation of the electronic device 900. The processing apparatus 901, the ROM 902, and the RAM 903 are connected to each other through a bus 904. An input/output (I/O) interface 905 is also connected to the bus 904.

Generally, the following apparatuses may be connected to the I/O interface 905: an input apparatus 906 including, for example, a touch screen, a touchpad, a keyboard, a mouse, a camera, a microphone, an accelerometer, a gyroscope, etc.; an output apparatus 907 including, for example, a liquid crystal display (LCD), a speaker, a vibrator, etc.; a storage apparatus 908 including, for example, a magnetic tape, a hard disk, etc.; and a communication apparatus 909. The communication apparatus 909 may allow the electronic device 900 to perform wireless or wired communication with other devices to exchange data. Although FIG. 9 shows the electronic device 900 having various apparatuses, it should be understood that it is not required to implement or have all of the illustrated apparatuses. Alternatively, more or fewer apparatuses may be implemented or provided.

In particular, according to the embodiments of the present disclosure, the processes described above with reference to the flowcharts may be implemented as a computer software program. For example, an embodiment of the present disclosure includes a computer program product, which includes a computer program carried on a non-transitory computer-readable medium, and the computer program includes program codes for executing the method shown in the flowcharts. In such an embodiment, the computer program may be downloaded and installed from a network through the communication apparatus 909, or installed from the storage apparatus 908, or installed from the ROM 902. When the computer program is executed by the processing apparatus 901, the above-mentioned functions defined in the methods of the embodiments of the present disclosure are executed.

It should be noted that the above computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus, or device, or any combination thereof. A more specific example of the computer-readable storage medium may include, but is not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program that can be used by or in combination with an instruction execution system, apparatus, or device. In the present disclosure, the computer-readable signal medium may include a data signal propagated in a baseband or as a part of a carrier wave, and computer-readable program codes are carried in the data signal. This propagated data signal may take many forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program codes contained in the computer-readable medium may be transmitted by any suitable medium, including but not limited to an electric wire, an optical cable, a radio frequency (RF), etc., or any suitable combination thereof.

In some implementations, the terminal device may communicate using any currently known or future developed network protocol such as the Hypertext Transfer Protocol (HTTP), and may be interconnected with any form or medium of digital data communication (for example, a communication network). Examples of the communication network include a local area network (“LAN”), a wide area network (“WAN”), an internetwork (for example, the Internet), and a peer-to-peer network (for example, an ad hoc peer-to-peer network), as well as any currently known or future developed network.

The above computer-readable medium may be included in the above electronic device, or may exist alone without being assembled into the electronic device.

The above computer-readable medium carries one or more programs, and when the one or more programs are executed by the electronic device, the electronic device is caused to: display a first multimedia resource and a second multimedia resource, where the first multimedia resource and the second multimedia resource are multimedia resources associated with a target object; and display that at least part of a target element in the first multimedia resource moves to the second multimedia resource, where the at least part of the target element is an element associated with the target object.

The computer program codes for performing the operations of the present disclosure may be written in one or more programming languages or a combination thereof. The above programming languages include but are not limited to object-oriented programming languages, such as Java, Smalltalk, C++, and also include conventional procedural programming languages, such as “C” language or similar programming languages. The program codes may be executed entirely on a user's computer, partly on a user's computer, as a stand-alone software package, partly on a user's computer and partly on a remote computer, or entirely on a remote computer or a server. In the case involving the remote computer, the remote computer may be connected to the user's computer through any kind of network, including a local area network (LAN) or a wide area network (WAN), or may be connected to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, and the module, the program segment, or the portion of codes contains one or more executable instructions for implementing specified logical functions. It should also be noted that, in some alternative implementations, the functions marked in the blocks may also occur in a different order than those marked in the drawings. For example, two blocks shown in succession may, in fact, be executed substantially concurrently, or the two blocks may sometimes be executed in a reverse order, depending upon the functionality involved. It should also be noted that each block of the block diagrams and/or flowcharts, and a combination of blocks in the block diagrams and/or flowcharts, may be implemented by a dedicated hardware-based system that performs the specified functions or operations, or may also be implemented by a combination of dedicated hardware and computer instructions.

The modules involved in the embodiments of the present disclosure may be implemented in software or hardware. The name of a module does not constitute a limitation of the module itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium may include an electrical connection with one or more wires, a portable computer disk, a hard disk, a random-access memory (RAM), a read-only memory (ROM), an erasable programmable read-only memory (EPROM or a flash memory), an optical fiber, a portable compact disc read-only memory (CD-ROM), an optical storage device, a magnetic storage device, or any suitable combination thereof.

The above description is only preferred embodiments of the present disclosure and an illustration of the applied technical principles. Those skilled in the art should understand that the scope of disclosure involved in the present disclosure is not limited to the technical solutions formed by the specific combination of the above technical features, and should also cover other technical solutions formed by any combination of the above technical features or equivalent features thereof without departing from the above disclosed concept, for example, a technical solution formed by replacing the above features with technical features with similar functions disclosed in the present disclosure (but not limited to).

In addition, although various operations are depicted in a specific order, this should not be understood as requiring these operations to be performed in the specific order shown or in a sequential order. Under certain circumstances, multitasking and parallel processing may be advantageous. Similarly, although the above discussion contains several specific implementation details, these should not be construed as limiting the scope of the present disclosure. Certain features that are described in the context of separate embodiments may also be implemented in combination in a single embodiment. Conversely, various features that are described in the context of a single embodiment may also be implemented in multiple embodiments individually or in any suitable sub-combination.

Although the subject matter has been described in language specific to structural features and/or logical actions of methods, it should be understood that the subject matter defined in the appended claims is not necessarily limited to the specific features or actions described above. Rather, the specific features and actions described above are merely example forms of implementing the claims. Regarding the apparatus in the above embodiments, the specific manners in which the modules perform operations have been described in detail in the embodiments related to the method, and will not be described in detail here.

1. An information presentation method, comprising:
displaying a first multimedia resource and a second multimedia resource, wherein the first multimedia resource and the second multimedia resource are multimedia resources associated with a target object; and
displaying at least portion of a target element in the first multimedia resource moving to the second multimedia resource, wherein the at least portion of the target element is an element associated with the target object.

2. The method according to claim 1, wherein the displaying the first multimedia resource and the second multimedia resource comprises:
displaying the first multimedia resource in a first area of an application interface, and displaying a corresponding information presentation page for presenting the target object in a second area of the application interface, wherein the second multimedia resource is displayed on the information presentation page.

3. The method according to claim 2, wherein the displaying the at least portion of the target element in the first multimedia resource moving to the second multimedia resource comprises:
displaying the target element moving from a lower layer of the information presentation page to the second multimedia resource.

4. The method according to claim 2, wherein the displaying the first multimedia resource in the first area of the application interface comprises:
displaying the first multimedia resource in a first area of a resource display layer located at an upper layer of the application interface, wherein the first multimedia resource displayed in the first area of the resource display layer is capable of interacting with an interface element of the application interface to form a glasses-free three-dimensional effect.

5. The method according to claim 4, wherein the second multimedia resource is displayed in a second area of the resource display layer, and the information presentation page is displayed through a page layer located at an upper layer of the resource display layer.

6. The method according to claim 1, further comprising:
displaying the target element moved to the second multimedia resource as a jump control, wherein the jump control is configured to display a landing page associated with the target object in response to a trigger operation.

7. The method according to claim 1, wherein the displaying the at least portion of the target element in the first multimedia resource moving to the second multimedia resource comprises:
displaying a preset animation resource on the first multimedia resource, wherein the preset animation resource is used to describe the target element moving to the second multimedia resource.

8. A non-transitory computer-readable medium having a computer program stored thereon, wherein the computer program, when executed by a processing apparatus, implements an information presentation method, and the information presentation method comprises:
displaying a first multimedia resource and a second multimedia resource, wherein the first multimedia resource and the second multimedia resource are multimedia resources associated with a target object; and
displaying at least portion of a target element in the first multimedia resource moving to the second multimedia resource, wherein the at least portion of the target element is an element associated with the target object.

9. The non-transitory computer-readable medium according to claim 8, wherein the displaying the first multimedia resource and the second multimedia resource comprises:
displaying the first multimedia resource in a first area of an application interface, and displaying a corresponding information presentation page for presenting the target object in a second area of the application interface, wherein the second multimedia resource is displayed on the information presentation page.

10. The non-transitory computer-readable medium according to claim 9, wherein the displaying the at least portion of the target element in the first multimedia resource moving to the second multimedia resource comprises:
displaying the target element moving from a lower layer of the information presentation page to the second multimedia resource.

11. The non-transitory computer-readable medium according to claim 9, wherein the displaying the first multimedia resource in the first area of the application interface comprises:
displaying the first multimedia resource in a first area of a resource display layer located at an upper layer of the application interface, wherein the first multimedia resource displayed in the first area of the resource display layer is capable of interacting with an interface element of the application interface to form a glasses-free three-dimensional effect.

12. The non-transitory computer-readable medium according to claim 11, wherein the second multimedia resource is displayed in a second area of the resource display layer, and the information presentation page is displayed through a page layer located at an upper layer of the resource display layer.

13. The non-transitory computer-readable medium according to claim 8, wherein the information presentation method further comprises:
displaying the target element moved to the second multimedia resource as a jump control, wherein the jump control is configured to display a landing page associated with the target object in response to a trigger operation.

14. An electronic device, comprising:
a storage apparatus having a computer program stored thereon; and
a processing apparatus, configured to execute the computer program in the storage apparatus to implement an information presentation method, and the information presentation method comprises:
displaying a first multimedia resource and a second multimedia resource, wherein the first multimedia resource and the second multimedia resource are multimedia resources associated with a target object; and
displaying at least portion of a target element in the first multimedia resource moving to the second multimedia resource, wherein the at least portion of the target element is an element associated with the target object.

15. The electronic device according to claim 14, wherein the displaying the first multimedia resource and the second multimedia resource comprises:
displaying the first multimedia resource in a first area of an application interface, and displaying a corresponding information presentation page for presenting the target object in a second area of the application interface, wherein the second multimedia resource is displayed on the information presentation page.

16. The electronic device according to claim 15, wherein the displaying the at least portion of the target element in the first multimedia resource moving to the second multimedia resource comprises:
displaying the target element moving from a lower layer of the information presentation page to the second multimedia resource.

17. The electronic device according to claim 15, wherein the displaying the first multimedia resource in the first area of the application interface comprises:
displaying the first multimedia resource in a first area of a resource display layer located at an upper layer of the application interface, wherein the first multimedia resource displayed in the first area of the resource display layer is capable of interacting with an interface element of the application interface to form a glasses-free three-dimensional effect.

18. The electronic device according to claim 17, wherein the second multimedia resource is displayed in a second area of the resource display layer, and the information presentation page is displayed through a page layer located at an upper layer of the resource display layer.

19. The electronic device according to claim 14, wherein the information presentation method further comprises:
displaying the target element moved to the second multimedia resource as a jump control, wherein the jump control is configured to display a landing page associated with the target object in response to a trigger operation.

20. The electronic device according to claim 14, wherein the displaying the at least portion of the target element in the first multimedia resource moving to the second multimedia resource comprises:
displaying a preset animation resource on the first multimedia resource, wherein the preset animation resource is used to describe the target element moving to the second multimedia resource.
